(19) United States
(12) Patent Application Publication
(10) Pub. No.: US 2007/0069145 A1
(43) Pub. Date: Mar. 29, 2007

(54) Procedure and facility for providing proof of dangerous goods in pieces of baggage

(75) Inventor: Juergen Leonhardt, Berlin (DE)

Correspondence Address: SHERIDAN ROSS PC, 1560 BROADWAY, SUITE 1200, DENVER, CO, 80202, US

(73) Assignee: INSTITUT FUR UMWELTTECHNOLOGIEN GMBH, D-12489 BERLIN (DE)

(21) Appl. No.: 10/556,972

(22) PCT Filed: May 11, 2004
(86) PCT No.: PCT/DE04/01019

§ 371 Date: Nov. 15, 2005

(30) Foreign Application Priority Data
May 16, 2003 (DE) 103 23 093.9

(51) Int. Cl. G01N 23/00

(52) U.S. Cl. 250/390.04

(57) ABSTRACT

The invention relates to a procedure and a facility which can be used to quickly and reliably discover and identify dangerous goods, such as explosives, chemical warfare agents or narcotics in pieces of baggage. For this purpose, the pieces of baggage to be examined are radiated with fast neutrons. For assessment, a time-resolved gathering of the occurring thermal neutrons as well as deconvolution of their decay curves and registration of the induced gamma radiation due to inelastic scattering and capturing radiation are carried out.

The invention relates to a procedure and a facility, which can be used to quickly and reliably discover and identify dangerous goods, such as explosives, chemical warfare agents or narcotics in pieces of baggage.

In the general state of the art, a large number of solutions are known which, by applying nuclear-physical methods, e.g. fast neutrons, thermal neutrons, γ-radiation as well as mapping systems, deal with the search of pieces of baggage and containers for explosives, drugs etc. by using X-radiation. All these solutions have in common that they do not realize quick and unique identifications of explosives/drugs and other dangerous goods with sufficient reliability.

In the face of the growing threats of terrorist attacks, the non-contact online-measurement of hidden explosives, chemical warfare agents and biological material in closed containers will be of increasing importance.

The use of neutrons for analytical procedures in industry, agriculture, medicine, and research has a long tradition. The activation analysis (NAA) is mainly dependent on stationary neutron sources, such as research reactors and neutron generators, which show necessarily high fluxes in order to determine element contents in the lower trace range. The use of mobile neutron sources in the geophysical bore hole reconnaissance (neutron carrotage) involved isotope neutron sources, such as ²⁵²Cf, ²⁴¹Am/Be (up to 10⁶ neutrons per second) as well as miniaturized neutron generators which, by using D/T (Deuterium/Tritium)-fusion reaction, can yield mono-energetic 14 MeV-neutrons and reach emission rates of up to some 10⁸n/s.

In mining, relatively simple analytical arrangements are used for online-determination of metal contents in ores, Mg/Ca-contents in table or potassium salts on conveyor belts. In metallurgy, oxygen determination in aluminum or silicon determination in coal belong to the analytical routines.

Sum effects, such as thermalization of fast neutrons to preferably light nuclei, such as hydrogen, make further applications possible, such as the non-contact measurement of phase limits between water and benzene in tanks, water and crude petroleum in pipelines or ash contents in oil.

Within the framework of Deminig-projects, the neutron backscatter procedure has become very important to the identification of explosives in landmines. The problem of mine search by means of metal detectors lies in the high alarm rate for wrongly positive alarms, released by metal clusters in the soil. For this purpose, investigations revealing that neutron procedures reduce these false alarm rates considerably were carried out on exercise fields with good results. Likewise, an interesting approach to an improved identification of organic matters has resulted when the moderation of fast neutrons could be gathered together with the prompt gamma radiation, which occurs as a result of inelastic scattering and capture of neutrons.

The current aspects of the fight against terrorism require a fast identification of explosives (down to amounts of 10 g) in containers (vacuum-packed, metal), which might be found in suitcases/bags or also in transport containers.

Thus, it was the object of the invention to define a solution which makes it possible to quickly, uniquely and reliably track down dangerous goods in closed containers, which has a low detection limit and minimizes the number of indication errors caused by wrong recognitions.

The application of nuclear radiation makes the direct determination of these substances and their identification to a large extent possible.

Therefore, a system for checking baggage and transport containers has been developed. It consists of the following components:
(1) Neutron generator, miniaturized, for 14 MeV-neutrons
(2) High-voltage generator, 120 kV, DC and pulsed
(3) Neutron detectors for thermalized neutrons, BF₆ and ³He
(4) Gamma detectors, spectrometric
(5) Electronic part with supplies, amplifiers, coincidence stages, computers, and displays

The solution lies in the combined use of neutron moderation and induced gamma radiation:
(a) Time-resolved gathering of the occurring thermal neutrons and deconvolution of their decay curves,
(b) Correlation of the gamma-peaks for C, O, N (through O), Cl, F and H as a result of inelastic scattering and capture radiation as well as correlation with real objects.

The figures show:

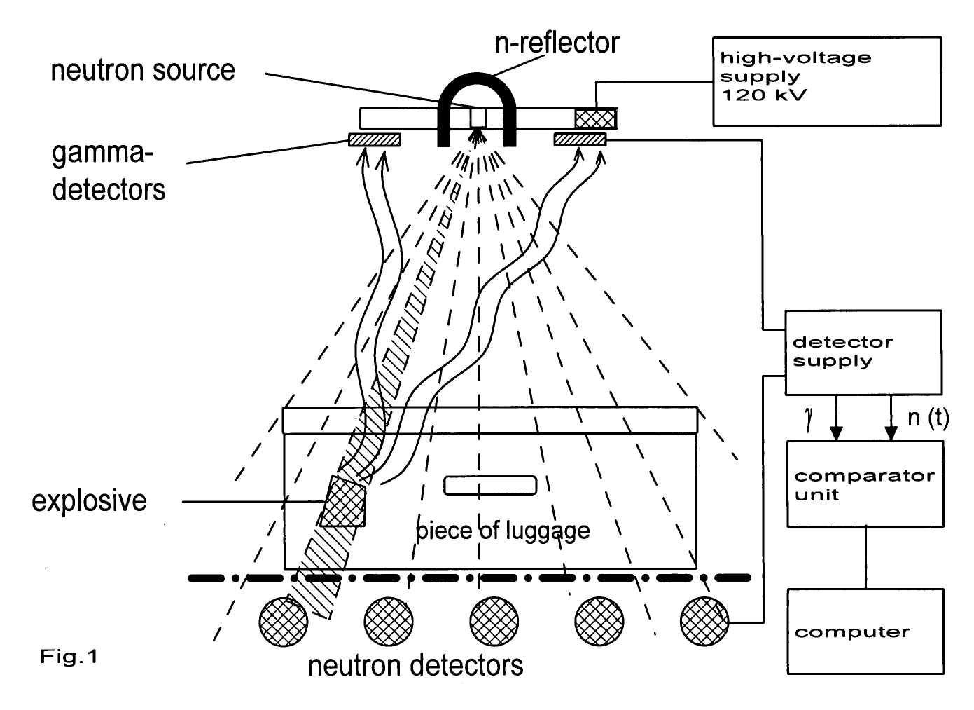

FIG. 1 Sectional view of the facility

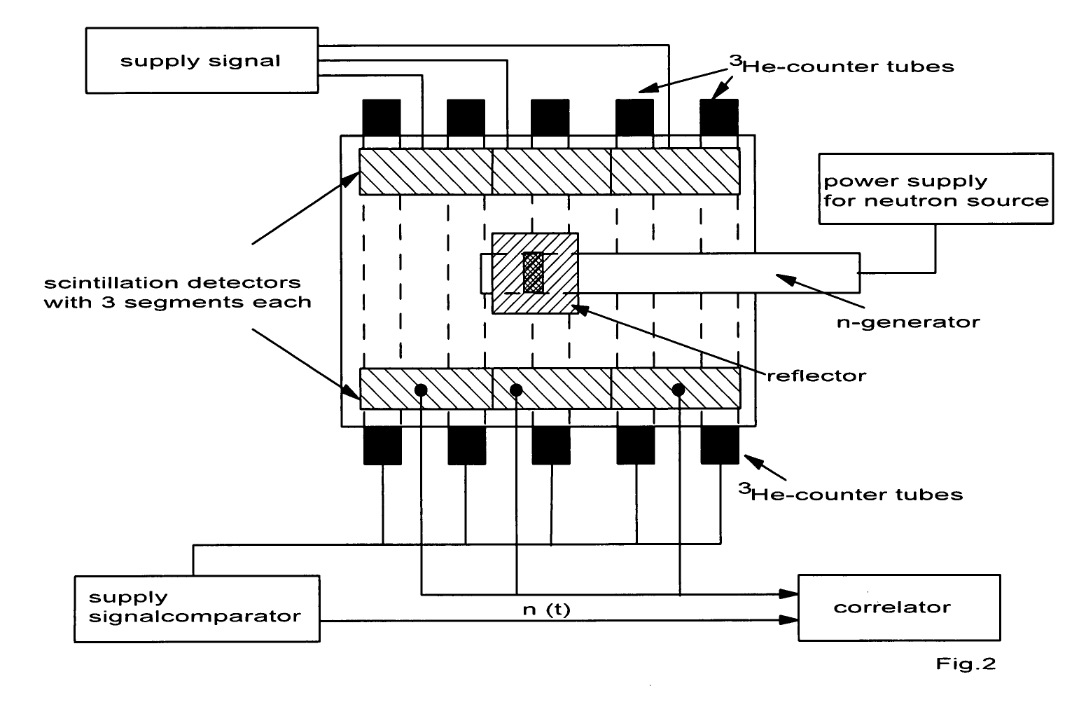

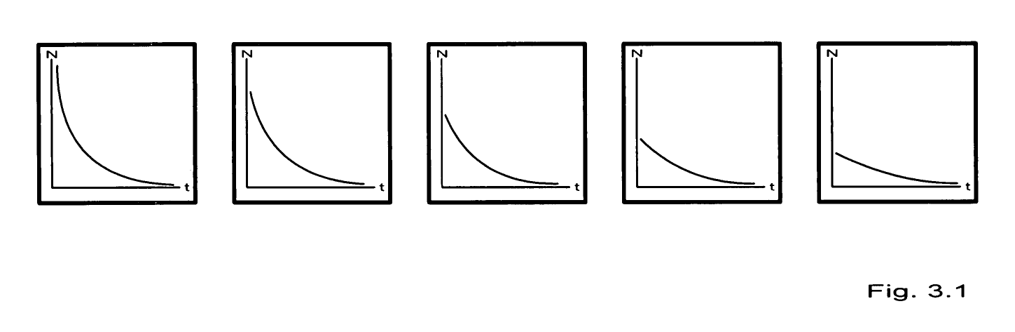

FIG. 2 Top view

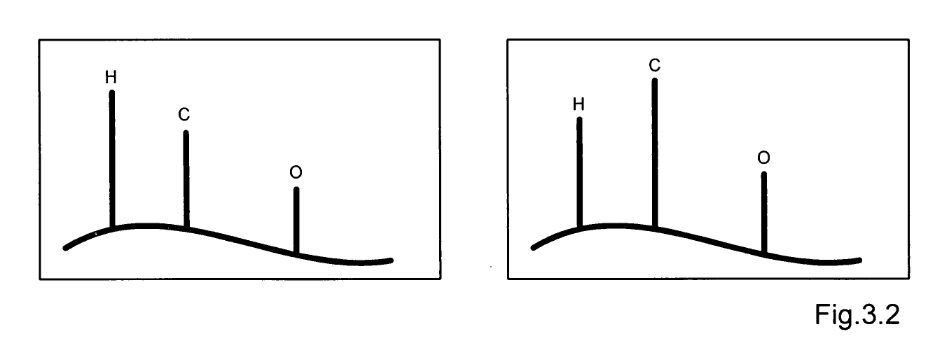

FIG. 3.1 Time profiles of the neutron detectors 1 to 5

FIG. 3.2 γ-spectra, isochronous

The principle NEUTROSCAN is schematically illustrated in FIG. 1 in sectional view and in FIG. 2 in top view in order to illustrate the objective.

The 14 MeV-neutrons were emitted and, by using a reflector, directed to the suitcase on the conveying belt. In the explosive, a special thermalization takes place and is registered in Detector 1.

The explosive being present in the suitcase causes an increased counting rate of the thermalized neutrons at Detector 1, which indicates that there is the possibility of existing explosives (and/or drugs etc.). If gamma quanta, typical of C, O and (N), get to the gamma detectors at the same time, the explosive will be identified. The type of explosive results from the proportions of hydrogen to oxygen and carbon to oxygen/nitrogen. If Cl- and F-lines occur, chemical warfare agents will be concerned. If Si occurs, it can be concluded that a glass container is involved.

FIG. 2 shows the top view of the facility according to the invention.

In case of explosives being present, the following pictures are shown at the detectors:

The time profiles (FIG. 3.1) at the neutron detectors 1-5 show which typical signal would cause the existence of explosives in the transport container at the specified point. The γ-spectra (FIG. 3.2) that were taken at the same time are placed in relation to neutron detection curves by means of a coincidence facility and thus make a unique identification of the typical dangerous materials possible.

The appearance of C, O due to inelastic scattering verifies the existence of explosives/drugs.

The facility is characterized by
a switchable miniaturized neutron source with an emission rate of some 10⁸ neutrons per second. This makes a flux density of 104 neutrons/cm²·s), related to a suitcase cross-section of 1 m², possible which is required for a safe detection of explosives having a weight of 10 g (TNT, RDX . . . ).
Activation of a directed 14 MeV-neutron ray by adding an effective reflector to the neutron source, which makes an approximate 2π,-geometry possible.

Arrangement of detectors for gathering thermalized neutrons in dependence on their decay behavior. For this purpose, a detector array consisting of ³He- or ¹⁰BF₃-counting tubes is used. If one or several of these detectors show an abnormally high number of thermalized neutrons, they have passed a high hydrogen nucleus concentration during baggage passage.
Arrangement of gamma-detectors which make the proof of induced gamma radiations of hydrogen, carbon, oxygen, silicon, and nitrogen as well as other elements spectrometrically possible.
Control electronics for data fusion of the signals supplied by the neutron and gamma detectors.
Coincidence apparatus as part of data processing, which makes the time allocation of n-time spectra and gamma spectra and thus identification of explosives possible.
Reference computer with a library of typical “fingerprints” of typical baggage contents with and without explosives.
Correlation measurements at a functional model of NeutroScan by means of real pieces of baggage.
Design of biological screening units, which slow down and then absorb fast neutrons in sandwich arrangement.

The procedure is characterized by the sections
Spectrometry (Time, Energy)
The set-up of measuring instruments for capturing thermalized neutrons shall result in time-resolved spectra, which give information about the covered distance and materials that have passed on this way, in which the time-resolved curves are decoded (calibrated, standardized) by means of typical patterns.
Coincidence Stage
For gathering isochronous events in the gamma- and neutron spectrum, the coincidence stage, which makes a better localization of interesting substances possible, is used.
Time Dependency
The time dependency of thermalized neutrons depending on various standard arrangements makes the determination of wrongly positive/negative alarm rates possible.
Deconvolution of Decay Curves
Dependent on the atomic number and the density of the passed materials, the deconvolution of decay curves of thermalized neutrons includes deviations from the ideal form of decay in homogenous media. These media are used as characteristic information after the Fourier transformation and Wafelet-procedure, respectively.
Data Fusion of Neutron Spectra and Gamma Data
Data fusion of neutron spectra and gamma data will state hidden explosives (high O-content!!) more precisely. For this reason, correlations with standard materials are carried out.

In a program library, the computer system contains information from a “learning” (calibration) process in which the following data connections achieved from comparative measurements with real systems are included:

Function Signal=F (Geometry and content of suitcases)
According to the results of data fusion, correlation examinations were conducted with real systems, such as suitcases and bags of differing contents. The function Signal=F (geometry and content of suitcases) was determined for a great number of cases which are filed in a library. After having determined as many relations of the function Signal=F (geometry and content of suitcases) as possible for real systems, the FP/FN-rates of the system are determined.

As a result of the correlation investigations, the design of a library with typical patterns became possible, to which a fast access in the internal computer is possible. An equalization of current spectra as well as spectra filed in the library is possible in cycles of seconds.

1. A method for the detection of dangerous goods in pieces of baggage, comprising:
irradiating 14 MeV-neutrons to a container to be examined from a pulsed neutron source;
arranging an array of neutron counting tubes below a transport facility for the containers to be examined;
assessing signals from the tubes in terms of a time-related decay behavior of thermalized neutrons;
providing statements about the existence of at least one of N-, O-, C-, Cl-, Si-, and F-atoms;
receiving induced γ-radiation at scintillator detectors;
comparing signals of the time-related decay behavior of the thermalized neutrons with signals from the scintillator detectors;
assessing the signals using a coincidence arrangement;
obtaining statements about the existence and quantitative proportion of the at least one of N, O, C, Cl, Si, and F atoms; and
determining the presence and quantity of explosives, drugs, and warfare agents in the container by assessing the statements and comparing them with a computer calibrated at real objects.

2. The method according to claim 1, wherein the radiation of the pulsed neutron source is varied with regard to energy by means of moderators arranged in between.

3. A facility for providing proof of dangerous goods in pieces of baggage, comprising:
a pulsed neutron source arranged above a transport facility for containers to be examined;
a neutron flux from the neutron source directed to the containers by means of a neutron reflector;
an array of neutron counting tubes arranged below the transport facility in order to provide proof of time-related decay behavior of thermalized;
gamma-detectors adapted to receive induced gamma radiation; and
a coincidence and a computer arrangement adapted to assess the timerelated decay behavior of the thermalized neutrons and the induced gamma radiation.

4. The facility according to claim 3, wherein the radiation-exposed areas is screened by sandwich structures.

5. The facility according to claim 3, wherein the array of neutron counting tubes comprises BF6-counting tubes.

6. The facility according to claim 3, wherein the array from neutron counting tubes is realized comprises 3He-counting tubes.

7. The facility according to claim 4, wherein the array of neutron counting tubes comprises BF6-counting tubes.

8. The facility according to claim 4, wherein the array from neutron counting tubes comprises 3He-counting tubes.
